(19) United States
(12) Patent Application Publication
(10) Pub. No.: US 2019/0208088 A1
(43) Pub. Date: Jul. 4, 2019

(54) Image Processing Apparatus, Image Processing Method, and Recording Medium

(71) Applicant: Kyocera Document Solutions Inc., Osaka (JP)

(72) Inventor: Naoki Nakajima, Osaka (JP)

(73) Assignee: Kyocera Document Solutions Inc.

(21) Appl. No.: 16/234,627

(22) Filed: Dec. 28, 2018

(30) Foreign Application Priority Data
Dec. 28, 2017 (JP) 2017-252850

(51) Int. Cl. H04N 1/62; H04N 1/00

(52) U.S. Cl. CPC H04N 1/62; H04N 1/00482

(57) ABSTRACT

An image processing apparatus includes an image data receiving unit, an image analysis unit, and an image processing unit. The image data receiving unit receives image data representing an input image. The image analysis unit analyzes the input image data, detects an image region representing a drawing target from the input image, and identifies a background image region as an image region excluding the detected image region representing the drawing target. The image processing unit extracts a show-through image from the background image region, adjusts a lightness of the extracted show-through image, and decreases a visibility of the show-through image while maintaining an image of the image region representing the drawing target.

### INCORPORATION BY REFERENCE

This application is based upon, wherein the benefit of priority is claimed from, corresponding Japanese Patent Application No. 2017-252850, filed in the Japanese Patent Office on Dec. 28, 2017, and the entire contents of which are incorporated herein by reference.

### BACKGROUND

Unless otherwise indicated herein, the description in this section is not prior art to the claims in this application and is not admitted to be prior art by inclusion in this section.

Many image forming apparatuses are capable of duplex printing, and they are widespread. In duplex printing, since images are formed on both the front and back sides of a printing paper sheet, a show-through problem sometimes occurs. “Show-through,” also referred to as “bleed-through,” is a situation where an image printed on one side of a sheet shows through onto the other side of the sheet. Such show-through degrades visibility of the printed image in image reading/scanning and causes decrease in fidelity of image data to a document image. For such problems, there has been proposed a technique where an image data analyzing unit determines a background color of input image data, and a color space changing unit maps pixels having colors within a predetermined range from the determined background color in the image data with a color identical to the determined background color so as to perform a show-through reduction process. This technique ensures the show-through reduction process while maintaining the color of the background part of the image data.

### SUMMARY

An image processing apparatus according to one aspect of the disclosure includes an image data receiving unit, an image analysis unit, and an image processing unit. The image data receiving unit receives image data representing an input image. The image analysis unit analyzes the input image data, detects an image region representing a drawing target from the input image, and identifies a background image region as an image region excluding the detected image region representing the drawing target. The image processing unit extracts a show-through image from the background image region, adjusts a lightness of the extracted show-through image, and decreases a visibility of the show-through image while maintaining an image of the image region representing the drawing target.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of a functional configuration of an image forming system according to one embodiment of the disclosure.

FIG. 2 illustrates contents of a show-through reduction process according to the one embodiment.

FIGS. 3A and 3B illustrate contents of a drawing target image processing and a background image processing according to the one embodiment.

FIGS. 4A and 4B illustrate contents of the drawing target image processing and the background image processing according to the one embodiment.

FIGS. 5A and 5B illustrate respective histograms of a hue angle and a lightness index according to the one embodiment.

FIG. 6 illustrates an image on which the drawing target image processing and the background image processing have been performed according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes configurations to execute the disclosure (hereinafter referred to as “embodiment”) with reference to the drawings.

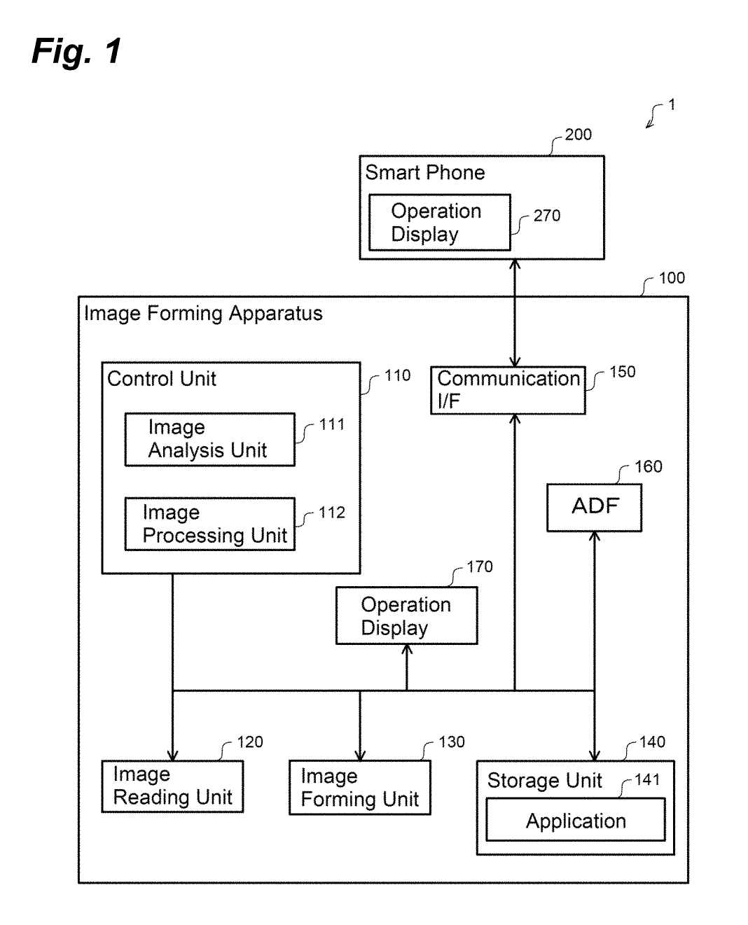

FIG. 1 illustrates a block diagram of a functional configuration of an image forming system 1 according to one embodiment of the disclosure. The image forming system 1 includes an image forming apparatus 100 and a smart phone 200. The image forming apparatus 100 includes a control unit 110, an image reading unit 120, an image forming unit 130, a storage unit 140, a communication interface unit (also referred to as communication I/F) 150, an automatic document feeder (ADF) 160, and an operation display 170. The control unit 110 includes an image analysis unit 111 and an image processing unit 112. The smart phone 200 includes an operation display 270.

The image forming apparatus 100 is connected to the smart phone 200 through short-range wireless communications using the communication interface unit 150. The smart phone 200 can serve as the image analysis unit 111 and the image processing unit 112 included in the control unit 110.

In this embodiment, Bluetooth® Class 2 is used for the short-range wireless communications. Bluetooth® Class 2, a protocol for a 2.5 mW maximum output, provides short-range wireless communications enabling transmission/reception between the image forming apparatus 100 and the smart phone 200 within a distance of about 10 m.

The control unit 110 includes a main storage unit such as a RAM and a ROM, and a control unit such as a micro-processing unit (MPU) and a central processing unit (CPU). The control unit 110 has a controller function related an interface such as various I/Os, a universal serial bus (USB), a bus, and another hardware, and controls the whole image forming apparatus 100.

The storage unit 140 is a storage device that includes a hard disk drive, a flash memory, or a similar medium, which are non-transitory recording media, and stores control programs (including an image processing program) and data for processes performed by the control unit 110. The storage unit 140 further stores an application program (simply referred to as an application) 141 as the image processing program installable in the smart phone 200.

The operation display 170 functions as a touch panel to display various menus as an entry screen. Further, the operation display 170 accepts an operation input by a user from various kinds of buttons and switches (not illustrated). The operation display 270 can be configured similar to the operation display 170.

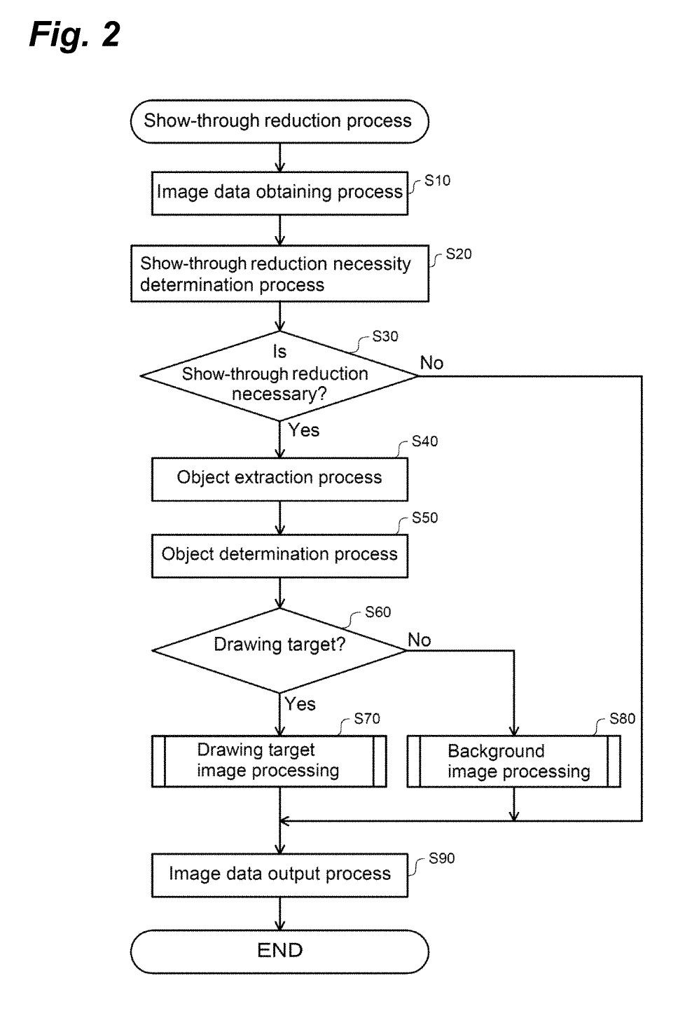

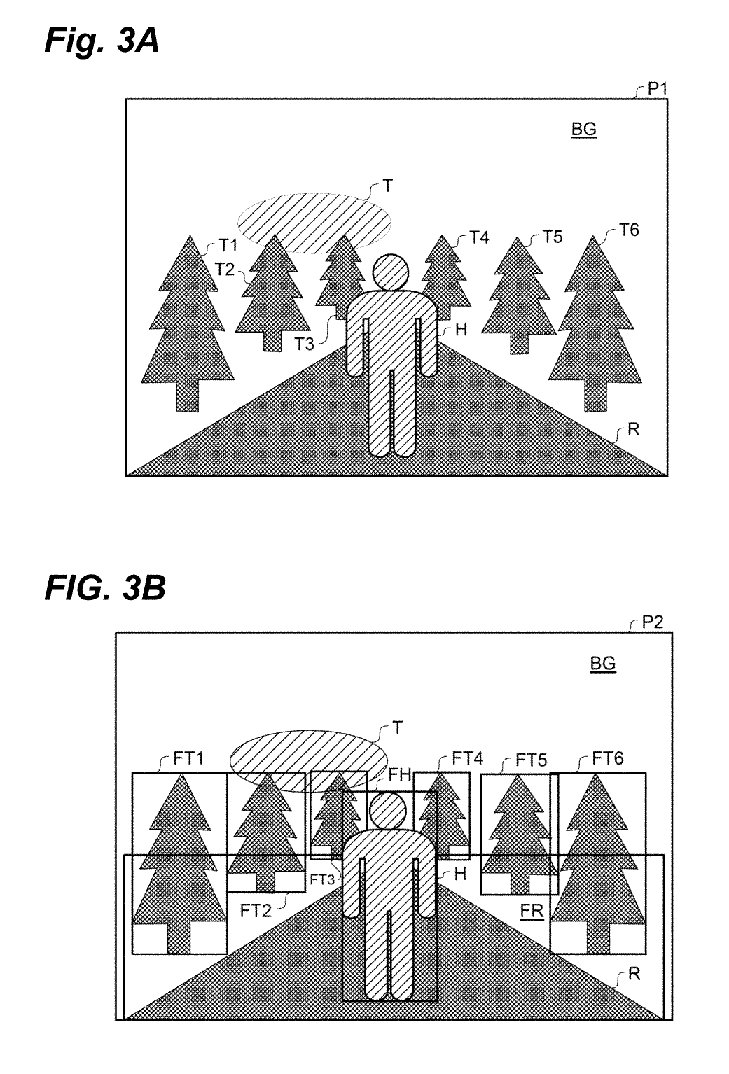

FIG. 2 illustrates contents of a show-through reduction process according to the one embodiment. FIGS. 3A and 3B illustrate contents of a drawing target image processing and a background image processing according to the one embodiment. FIG. 3A illustrates an image P1 that includes a blue sky as a background BG, six trees T1 to T6 constituting an avenue, a road R, a person H, and a show-through T.

In Step S10, the control unit 110 executes an image data obtaining process. In the image data obtaining process, the control unit 110 obtains image data representing the image P1 as an input image. The image data obtaining can include, for example, an image data obtaining by image reading with the image reading unit 120, and an image data obtaining by receiving from the smart phone 200 via the communication interface unit 150.

In this example, the image data is RGB image data that has RGB tone values (0 to 255) for each pixel. The image reading unit 120 and the communication interface unit 150 can serve as an image data receiving unit.

In Step S20, the control unit 110 executes a show-through reduction necessity determination process. In the show-through reduction necessity determination process, the control unit 110 determines whether or not the show-through reduction is necessary based on, for example, a setting input via the operation display 170.

As set contents, for example, a setting of a show-through reduction process mode that reduces the show-through can be done. In the show-through reduction process mode, for example, the following can be set: a processing mode that causes the image forming apparatus 100 to determine the necessity for the show-through reduction corresponding to the input of a type and a thickness as properties of a document paper sheet; and processing items for each type of subjects (for example, a person, a thing, and a structure). Specifically, only the person may be set as a drawing target, or all of the person, thing, and structure may be set as the drawing target.

In Step S30, the control unit 110 determines whether or not the show-through reduction is necessary. When the control unit 110 determines that the show-through reduction is necessary, the process proceeds to Step S40. Meanwhile, when the control unit 110 determines that the show-through reduction is no longer needed, that is, unnecessary, the process proceeds to Step S90, and an image analysis by the image analysis unit 111 (Steps S40 to S80) can be skipped.

In Step S40, the image analysis unit 111 in the control unit 110 executes an object extraction process. In the object extraction process, the image analysis unit 111 can detect persons, things, and structures, for example, using various kinds of publicly known methods such as Open Source Computer Vision Library (OpenCV), neural networks, and deep learning.

In this example, the image analysis unit 111 detects the person H, the six trees T1 to T6, and the road R as the objects, and displays a detection frame FH enclosing a region including the person H, detection frames FT1 to FT6 enclosing a region including the six trees T1 to T6, and a detection frame FR enclosing a region including the road R. The show-through T is not detected as the object because the show-through T is not the object such as a person.

The image analysis unit 111 can display an image P2, for example, where the detection frames F are superimposed on a peripheral area of the person H on the operation display 170. This ensures the user to confirm that the objects are appropriately extracted.

In Step S50, the image analysis unit 111 executes an object determination process. In the object determination process, the image analysis unit 111 determines the person H, the six trees T1 to T6, and the road R as the images in a person region, a thing region, and a structure region, respectively. The image analysis unit 111 determines other image regions as a background image region. The show-through T is treated as a part of the background image region. The background image region may include a background color of a document.

In Step S60, the image analysis unit 111 determines whether the drawing target is included or not for every image region based on the set contents in the show-through reduction process mode and the determination results. The drawing target means a subject in a photograph, and is an image intended to be drawn by the user of the image. The present inventor has found that the drawing target includes much image information and has a high spatial frequency, and the show-through is less likely to be recognized with a human sense of vision in the drawing target.

Thus, the user can freely set whether to determine the person region, the thing region, and the structure region as the drawing targets in the show-through reduction process mode. In an initial setting, the person region, the thing region, and the structure region are each set to the drawing target. In this example, the image forming apparatus 100 is assumed to be used in the initial setting. However, the setting of the show-through reduction process mode is not essential.

The image analysis unit 111 advances the process to Step S70 with the determination of the person region, the thing region, and the structure region as the drawing targets, and advances the process to Step S80 with the determination of the background image region as not the drawing target.

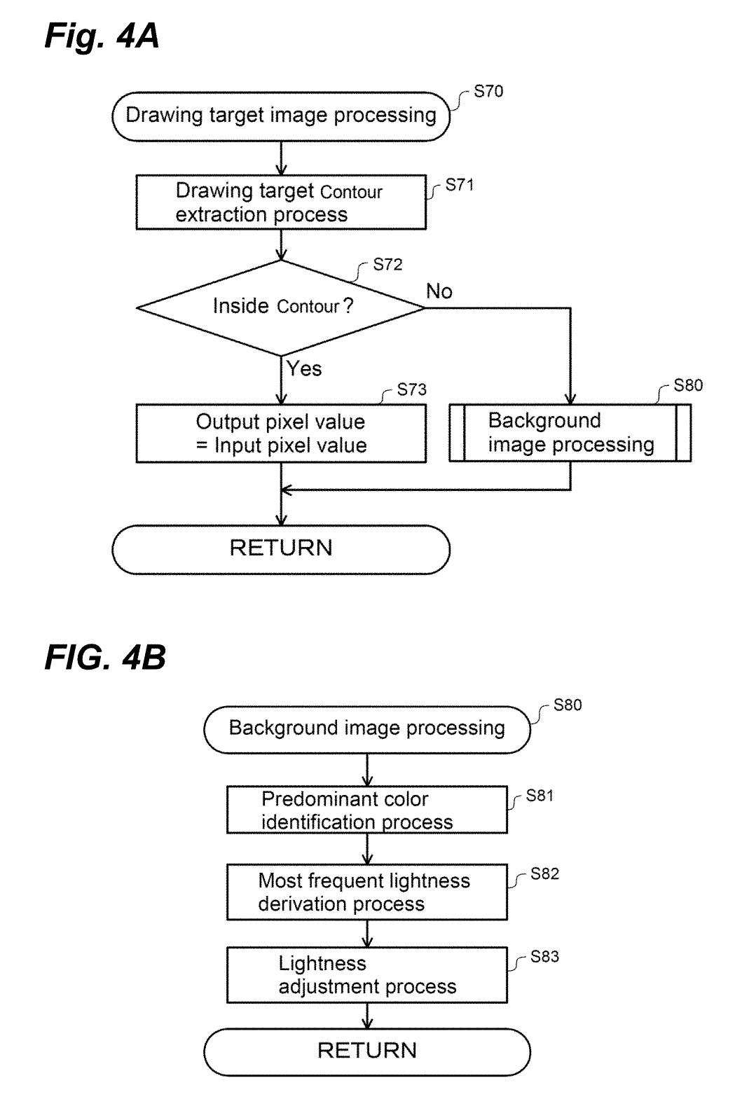

FIGS. 4A and 4B illustrate contents of the drawing target image processing (Step S70) and the background image processing (Step S80) according to the one embodiment. In this example, the drawing target image processing (Step S70) is applied to the images representing the person H, the six trees T1 to T6, and the road R, and the background image processing (Step S80) is applied to the background image region.

In Step S71, the image analysis unit 111 executes a drawing target contour extraction process. In the drawing target contour extraction process, the image analysis unit 111 extracts contours of the objects such as the person H, the six trees T1 to T6, and the road R in the detection frame FH, the detection frames FT1 to FT6, and the detection frame FR, respectively. The extraction of the contour may be performed, for example, using Sobel filter based on the respective tone values of RGB, or using various kinds of methods such as OpenCV, the neural network, and the deep learning.

In Step S72, the image analysis unit 111 determines whether or not the pixels are pixels inside the contour of the respective objects in the detection frame FH, the detection frame FT1 to FT6, and the detection frame FR. When the image analysis unit 111 determines the pixels as the pixels inside the contours of the respective objects, the process proceeds to Step S73, and when the image analysis unit 111 determines the pixels as not the pixels inside the contours of the respective objects, the process proceeds to Step S80.

In Step S73, the image processing unit 112 directly outputs input pixel values as output pixel values. With this process, the image processing unit 112 completes the drawing target image processing to the pixels inside the contours of the respective objects, thus the show-through reduction process (background image processing (Step S80)) described below can be skipped.

Thus, the image processing unit 112 can truly reproduce the images inside the contours of the respective objects. According to the finding of the present inventor, the drawing target includes much image information and has a high spatial frequency, and the show-through is less likely to be recognized with a human sense of vision in the drawing target. Accordingly, even if the show-through as a physical phenomenon occurs, it is preferred to give preference to the faithful reproduction of the image over the show-through.

Meanwhile, the pixels determined as not the pixels inside the contours of the respective objects inside the detection frames of the respective objects are regarded as the pixels in the background image region to be added to an application target of the background image processing.

In Step S80, the image analysis unit 111 executes the background image processing. In the background image processing, the image analysis unit 111 executes the show-through reduction process as an image processing to reduce the show-through. The image processing unit 112 converts a color space of the image data from an RGB color space to a Lab color space. A Lab value includes an L-value as a lightness index and a*b* as a chromaticness index. The L-value can be calculated as a luminance value (calculation formula: Y=(0.298912×R+0.586611×G+0.114478×B).

The Lab color space is a uniform color space that can be said to have a scale (unit) close to a human sense of vision. The uniform color space is a space of a color solid (equivalent to color space) where a distance (mental sense of distance) between colors mentally looks as identical color variation in the human visual system. Thus, the image analysis unit 111 uses the Lab color space to ensure simple execution of an analysis assuming the human visual system.

In Step S81, the image analysis unit 111 executes a predominant color identification process. In the predominant color identification process, the image analysis unit 111 identifies a hue of a predominant color, which is a color forming a basic tone of a coloring in the background image region, with a hue angle. The hue angle can be simply calculated from the chromaticness index.

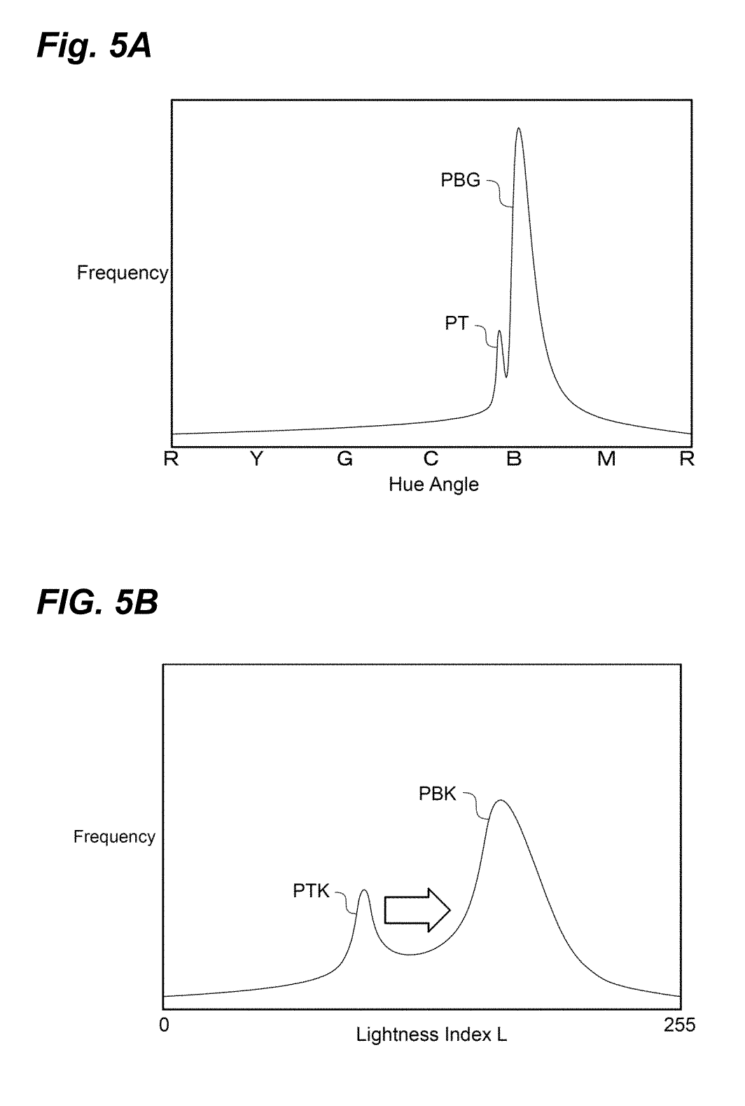

FIGS. 5A and 5B illustrate respective histograms of the hue angle and the lightness index according to the one embodiment. FIG. 5A illustrates the histogram of the hue angle. A horizontal axis indicates the hue angle and a vertical axis indicates a frequency of the pixel. The image analysis unit 111 generates the histogram of the hue angle using the pixels in the background image region.

The histogram of the hue angle has a maximum peak PBG on the hue angle near blue in the background BG of the blue sky, and has a peak PT of the show-through T as well. The image analysis unit 111 can identify the hue angle of the maximum peak PBG as the center of the hue angle of the predominant color. The image analysis unit 111 identifies a width in a range preliminarily set from the center of the hue angle of the predominant color as a range of the predominant color.

In Step S82, the image analysis unit 111 executes a most frequent lightness derivation process. In the most frequent lightness derivation process, the image analysis unit 111 extracts a plurality of pixels having the pixel values (colors) in the range of the predominant color to generate the histogram of the lightness index.

The histogram of the lightness index has a maximum peak PBK (mode) on the lightness index in the background BG of the blue sky, and has a peak PTK of the lightness index of the show-through T as well. The image analysis unit 111 can derive the lightness index of the maximum peak PBK as a most frequent lightness. The image analysis unit 111 searches a peak other than the maximum peak PBK (mode). In this example, the image analysis unit 111 can detect the peak PTK caused by a plurality of pixels constituting the show-through T.

The present inventor has found that the show-through forms another peak in a region with a lower lightness index compared with the background image in the background image region. That is, the inventor has found that the show-through T appears as an image like a shadow having a close hue in the background image region.

In Step S83, the image processing unit 112 executes a lightness adjustment process. In the lightness adjustment process, the image processing unit 112 extracts pixels having the pixel value (color) of the peak PTK in a range at the proximity of the peak PTK of the lightness index of the show-through T, and makes the lightness indexes of the extracted pixels close to the lightness index of the maximum peak PBK. Thus, the image processing unit 112 can decrease the visibility of the show-through T in the background BG of the blue sky.

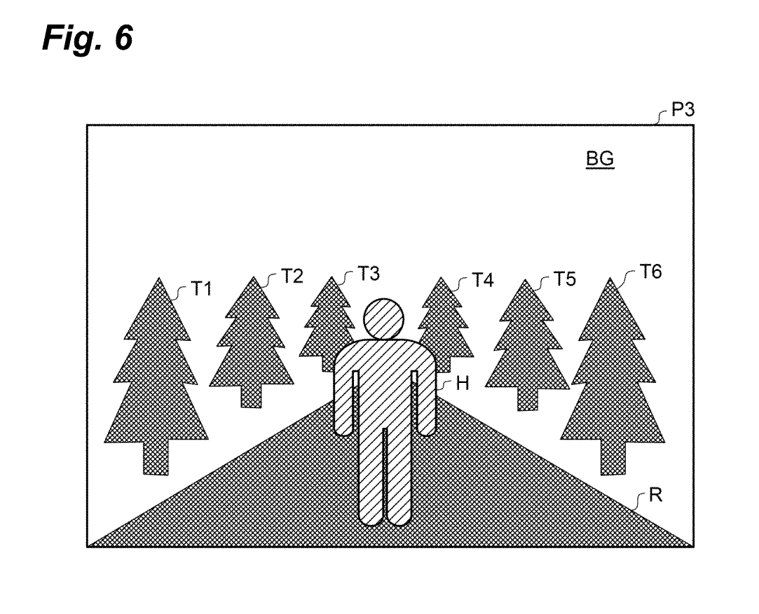

FIG. 6 illustrates an image on which the drawing target image processing and the background image processing have been performed according to the one embodiment. FIG. 6 illustrates an image P3 where the show-through T has disappeared through the drawing target image processing and the background image processing. In the image P3, the lightness index of the show-through T is increased to make the show-through T difficult to be recognized in the background BG of the blue sky, while the images in the objects including the insides of the contours of the two trees T2 and T3 are kept to maintain the faithful reproducibility.

In Step S90 (see FIG. 2), the control unit 110 executes an image data output process. In the image data output process, the control unit 110 can transmit the image data on which the image processing has been performed, and can output this image data as a printed matter.

Thus, the image forming system 1 according to the one embodiment prioritizes the faithful reproduction of the image because the drawing target includes much image information and the show-through is less likely to be recognized with a human sense of vision in the drawing target. Meanwhile, in the image region where the show-through is easily viewed, the lightness index of the image of the show-through is increased so as to make the show-through T difficult to be viewed. Accordingly, the visibility of the show-through can be decreased.

### Modifications

The disclosure can be executed with the following modifications in addition to the above-described embodiment.

### Modification 1

In the above-described embodiment, well-known various kinds of methods such as OpenCV, the neural network, the deep learning are used to detect the drawing target such as the person and the thing, thus reducing the show-through in the background region excluding the drawing target. However, not limited to such a method, a spatial frequency analysis of the image or entropy may be used. This is because, specifically, the human visual system easily recognizes the show-through in the image region where the spatial frequency of the image is low, and easily recognizes the show-through in the image region having smooth texture with low entropy.

### Modification 2

While the show-through is automatically extracted and the image processing is automatically performed in the above-described embodiment, the image forming apparatus 100 may be configured so as to highlight and display the extracted show-through extracted region on the operation display corresponding to the show-through detection and accept an input whether to perform the show-through reduction process from the user. With this configuration, the image processing is performed only to the show-through detection to which the user has given an instruction to perform the image processing, thus ensuring the processing following more the user's intension.

### Modification 3

In the above-described embodiment, when the image reading unit 120 of the image forming apparatus 100 executes a scanning process, the user input is accepted with the operation display 170 of the image forming apparatus 100. However, for example, a mobile terminal, including a smart phone and a tablet, configured to perform wireless communication with the image forming apparatus 100 may be used for the input of the setting and the highlight display of the show-through extracted region.

### Modification 4

While the disclosure is applied to the image forming apparatus in the above-described embodiment, the disclosure is applicable to an image processing apparatus or an image-reading apparatus.

### Exemplary Embodiment of the Disclosure

The image processing apparatus of the disclosure includes an image data receiving unit that receives image data representing an input image; an image analysis unit that analyzes the input image data, detects an image region representing a drawing target from the input image, and identifies a background image region as an image region excluding the detected image region representing the drawing target; and an image processing unit that extracts a show-through image from the background image region, adjusts a lightness of the extracted show-through image, and decreases a visibility of the show-through image while maintaining an image of the image region representing the drawing target.

The image processing method of the disclosure includes: receiving image data representing an input image; analyzing the input image data, detecting an image region representing a drawing target from the input image, and identifying a background image region as an image region excluding the detected image region representing the drawing target; and extracting a show-through image from the background image region, adjusting a lightness of the extracted show-through image, and decreasing a visibility of the show-through image while maintaining an image of the image region representing the drawing target.

The image processing program of the disclosure causes an image processing apparatus to function as: an image data receiving unit that receives image data representing an input image; an image analysis unit that analyzes the input image data, detects an image region representing a drawing target from the input image, and identifies a background image region as an image region excluding the detected image region representing the drawing target; and an image processing unit that extracts a show-through image from the background image region, adjusts a lightness of the extracted show-through image, and decreases a visibility of the show-through image while maintaining an image of the image region representing the drawing target.

### Effect of the Disclosure

The disclosure can provide a technique that ensures reduction of show-through visibility.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image processing apparatus comprising:
an image data receiving unit that receives image data representing an input image;
an image analysis unit that analyzes the input image data, detects an image region representing a drawing target from the input image, and identifies a background image region as an image region excluding the detected image region representing the drawing target; and
an image processing unit that extracts a show-through image from the background image region, adjusts a lightness of the extracted show-through image, and decreases a visibility of the show-through image while maintaining an image of the image region representing the drawing target.

2. The image processing apparatus according to claim 1, further comprising:
an operation display that accepts an input of a property of a document representing the input image; wherein
the image analysis unit determines a necessity of a show-through reduction based on the input, and skips an analysis of the image data when the image analysis unit has determined that the show-through reduction is unnecessary.

3. The image processing apparatus according to claim 1, wherein:
the image analysis unit identifies a hue range of a predominant color of the background image region, extracts a plurality of pixels that have pixel values within the hue range in the background image region, and derives a mode of lightness of the plurality of pixels; and
the image processing unit searches a peak other than the mode, and executes an image processing that makes the lightness of the pixels having the pixel value of the searched peak close to the lightness of the pixel value of the mode, as the adjustment.

4. The image processing apparatus according to claim 1, further comprising:
an operation display that highlights and displays the extracted show-through image, and accepts an input to instruct a reduction of the extracted show-through image; wherein
the image processing unit executes an image processing for the instructed show-through image reduction corresponding to the input as the adjustment.

5. The image processing apparatus according to claim 1, wherein the image processing unit converts a color space of the image data into a Lab color space, extracts the show-through image from the background image region in the Lab color space, and adjusts the lightness of the extracted show-through image.

6. An image processing method comprising:
receiving image data representing an input image;
analyzing the input image data, detecting an image region representing a drawing target from the input image, and identifying a background image region as an image region excluding the detected image region representing the drawing target; and
extracting a show-through image from the background image region, adjusting a lightness of the extracted show-through image, and decreasing a visibility of the show-through image while maintaining an image of the image region representing the drawing target.

7. A non-transitory computer-readable recording medium that stores an image processing program for controlling an image processing apparatus, the image processing program causing the image processing apparatus to function as:
an image data receiving unit that receives image data representing an input image;
an image analysis unit that analyzes the input image data, detects an image region representing a drawing target from the input image, and identifies a background image region as an image region excluding the detected image region representing the drawing target; and
an image processing unit that extracts a show-through image from the background image region, adjusts a lightness of the extracted show-through image, and decreases a visibility of the show-through image while maintaining an image of the image region representing the drawing target.
